(19) United States
(12) Patent Application Publication
(10) Pub. No.: US 2025/0278346 A1
(43) Pub. Date: Sep. 4, 2025

(54) ANOMALY DETECTION SYSTEM AND METHOD

(71) Applicant: SAMSUNG SDS CO., LTD., Seoul (KR)

(72) Inventors: Seung Ki HONG, Seoul (KR); Sung Min LEE, Seoul (KR); Jin Yeop CHANG, Seoul (KR)

(73) Assignee: SAMSUNG SDS CO., LTD., Seoul (KR)

(21) Appl. No.: 19/058,891

(22) Filed: Feb. 20, 2025

(30) Foreign Application Priority Data
Feb. 29, 2024 (KR) 10-2024-0030018

(51) Int. Cl. G06F 11/34

(52) U.S. Cl. CPC G06F 11/3452; G06F 11/3419; G06F 11/3466

(57) ABSTRACT

An anomaly detection system is provided. The anomaly detection system may comprise at least one processor and a memory storing a computer program executed by the at least one processor, wherein the computer program includes instructions for operations of: acquiring a neural network model configured to predict a metric value for a specific time point for a target system, outputting a predicted value for a specific metric via the neural network model, generating error data for the specific metric based on a difference between the predicted value and a measured value, estimating a distribution of errors for the specific metric using the generated error data, and performing anomaly determination for the specific metric by comparing the estimated distribution with a normal distribution, which is a distribution derived from error data for the specific metric obtained when the target system operates normally.

### CROSS-REFERENCE TO RELATED APPLICATION

This application claims priority from Korean Patent Application No 10-2024-0030018 filed on Feb. 29, 2024, in the Korean Intellectual Property Office, and all the benefits accruing therefrom under 35 U.S.C. 119, the contents of which in its entirety are herein incorporated by reference.

### BACKGROUND

### 1. Field

The present disclosure relates to an anomaly detection system and method.

### 2. Description of the Related Art

Various techniques for detecting anomalies in a system have been proposed. Most of these proposed techniques determine whether an anomaly has occurred in a target system based on a static threshold manually set by an administrator.

However, static threshold-based anomaly detection techniques have drawbacks, such as the inconvenience of requiring an administrator to manually set the threshold and the need for a specialized administrator, as the accuracy of anomaly detection is highly dependent on the set threshold. Furthermore, the static threshold-based anomaly detection techniques have difficulty adapting to dynamically changing anomaly patterns in a system and require continuous threshold adjustments.

### SUMMARY

The objectives of the present disclosure relate to a system and method capable of accurately detecting an anomaly in a target system (e.g., a microservice architecture-based cloud system).

Specifically, one objective of the present disclosure is to provide a system and method for accurately detecting an anomaly in a target system using metric data.

Another objective of the present disclosure is to provide a system and method for accurately detecting an anomaly in a target system using trace data.

Yet another objective of the present disclosure is to provide a system and method capable of overcoming the issues associated with threshold-based anomaly detection (e.g., the inconvenience of setting a threshold, the likelihood of anomaly detection accuracy being highly dependent on the set threshold, the requirement for a specialized administrator, and the need for continuous threshold adjustments).

The objectives of the present disclosure are not limited to those mentioned above, and other objectives not explicitly stated will be clearly understood by those skilled in the art based on the following description.

According to an aspect of the present disclosure, there is provided an anomaly detection system. The anomaly detection system may comprise at least one processor and a memory storing a computer program executed by the at least one processor, wherein the computer program includes instructions for operations of: acquiring a neural network model configured to predict a metric value for a specific time point for a target system, outputting a predicted value for a specific metric via the neural network model, generating error data for the specific metric based on a difference between the predicted value and a measured value, estimating a distribution of errors for the specific metric using the generated error data, and performing anomaly determination for the specific metric by comparing the estimated distribution with a normal distribution, which is a distribution derived from error data for the specific metric obtained when the target system operates normally.

In some embodiments, the neural network model is trained in an unsupervised or semi-supervised manner based on a normal metric dataset.

In some embodiments, the neural network model is trained through a task of predicting a metric value for a future time point based on input metric data.

In some embodiments, the neural network model is trained through a task of reconstructing, from input metric data, at least some metric values of the input metric data.

In some embodiments, the neural network model is configured to receive time-series data for a plurality of metrics, analyze the received time-series data, and output metric values for the specific time point for the plurality of metrics.

In some embodiments, the operation of estimating the distribution of errors for the specific metric comprises estimating the distribution of errors for the specific metric using a kernel density estimation (KDE) method.

In some embodiments, the operation of performing anomaly determination for the specific metric comprises determining whether the measured value for the specific metric is an outlier based on a degree of overlap between the estimated distribution and the normal distribution.

In some embodiments, the operation of determining whether the measured value for the specific metric is an outlier comprises determining that the measured value for the specific metric is an outlier when no overlap exists between the estimated distribution and the normal distribution.

In some embodiments, the operation of determining whether the measured value for the specific metric is an outlier comprises: determining a first representative value of the estimated distribution and a second representative value of the normal distribution; calculating a sum of probability values according to the estimated distribution and the normal distribution for each of at least some values in a section between the first and second representative values; and determining the degree of overlap by comparing a maximum of the calculated sums with zero.

In some embodiments, the target system is a microservice architecture-based system, the neural network model is configured to predict a metric value for a first microservice of the target system, and the computer program further includes instructions for operations of: acquiring another neural network model configured to predict a metric value at a specific time point for a second microservice of the target system; and performing anomaly determination for the second microservice using error data generated via the other neural network model.

According to another aspect of the present disclosure, there is provided an anomaly detection system. The system may comprise at least one processor and a memory storing a computer program executed by the at least one processor, wherein the computer program includes instructions for operations of: acquiring trace data related to at least one service of a target system, generating response time data for a specific service among the at least one service by analyzing the trace data, estimating a distribution of response times for the specific service using the generated response time data, and performing anomaly determination for the specific service by comparing the estimated distribution with a normal distribution, which is a distribution derived from response time data obtained when the specific service operates normally.

In some embodiments, the target system is a microservice architecture-based system.

In some embodiments, the trace data includes multiple trace records, and the operation of generating the response time data comprises: calculating a first plurality of response times for the specific service by analyzing a duration of a span associated with the specific service in each of the multiple trace records; determining a first representative response time based on the first plurality of response times; and generating the response time data including the first representative response time.

In some embodiments, the operation of determining the first representative response time comprises: determining the first representative response time based on response times that exceed a threshold, which is greater than a median of the first plurality of response times, among the first plurality of response times.

In some embodiments, the computer program further includes instructions for operations of: calculating a second plurality of response times for another service among the at least one service by analyzing the trace data, wherein a number of response times in the second plurality of response times differs from a number of response times in the first plurality of response times; determining a second representative response time based on the second plurality of response times; generating response time data for the other service including the second representative response time; and performing anomaly determination for the other service based on the response time data for the other service.

In some embodiments, wherein the operation of performing anomaly determination for the specific service comprises: determining whether an anomaly has occurred in the specific service based on a degree of overlap between the estimated distribution and the normal distribution.

In some embodiments, the operation of determining whether an anomaly has occurred in the specific service comprises: determining that an anomaly has occurred in the specific service when no overlap exists between the estimated distribution and the normal distribution.

In some embodiments, the operation of determining whether an anomaly has occurred in the specific service comprises: determining a first representative value of the estimated distribution and a second representative value of the normal distribution; calculating a sum of probability values according to the estimated distribution and the normal distribution for each of at least some values in a section between the first and second representative values; and determining the degree of overlap by comparing a maximum of the calculated sums with zero.

According to another aspect of the present disclosure, there is provided an anomaly detection method performed by at least one processor. The anomaly detection method may comprise acquiring a neural network model configured to predict a metric value for a specific time point for a target system, outputting a predicted value for a specific metric via the neural network model, generating error data for the specific metric based on a difference between the predicted value and a measured value, estimating a distribution of errors for the specific metric using the generated error data, and performing anomaly determination for the specific metric by comparing the estimated distribution with a normal distribution, wherein the normal distribution is a distribution derived from error data for the specific metric obtained when the target system operates normally.

According to another aspect of the present disclosure, there is provided an anomaly detection method performed by at least one processor. The anomaly detection method may comprise acquiring trace data related to at least one service of a target system, analyzing the trace data to generate response time data for a specific service among the at least one service, estimating a distribution of response times for the specific service using the generated response time data, and performing anomaly determination for the specific service by comparing the estimated distribution with a normal distribution, wherein the normal distribution is a distribution derived from response time data obtained when the specific service operates normally.

According to some embodiments of the present disclosure, predicted values for a specific metric can be obtained via a neural network model trained with a normal metric dataset, and the distribution of errors in the predicted values can be estimated from error data. By comparing the estimated error distribution with a normal error distribution, any anomaly in the specific metric can be accurately determined, enabling an accurate detection of an anomaly in the target system.

Additionally, since anomaly determination is performed based on whether an overlapping region exists between the estimated error distribution and the normal error distribution, there is no need to set a threshold. Consequently, various issues associated with threshold-based anomaly detection (e.g., the inconvenience of setting a threshold, the likelihood of anomaly detection accuracy being significantly affected by the set threshold, the requirement for a specialized administrator, the need for continuous threshold adjustments, and the like) can be easily resolved.

Furthermore, by continuously updating the normal error distribution, the problem of anomaly detection accuracy decreasing due to changes in anomaly patterns in the target system can also be effectively addressed.

Furthermore, response time data for a specific service may be generated by analyzing trace data, and the response time distribution for the specific service may be estimated from the response time data. Then, by comparing the estimated distribution with a normal distribution, an accurate anomaly determination can be performed for the service.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing exemplary embodiments thereof in detail with reference to the attached drawings, in which:

FIG. 1 is a diagram for explaining, at a system level, the operation of an anomaly detection system according to some embodiments of the present disclosure;

FIG. 2 is a diagram for explaining a case in which a target system is a microservice architecture-based system, according to some embodiments of the present disclosure;

FIG. 3 illustrates an example of metric data that may be referenced in some embodiments of the present disclosure;

FIGS. 4 and 5 are diagrams for explaining trace data that may be referenced in some embodiments of the present disclosure;

FIG. 6 is a flowchart for explaining an anomaly detection method according to some embodiments of the present disclosure;

FIGS. 7 and 8 are diagrams for explaining the structure and operation of a neural network model according to some embodiments of the present disclosure;

FIG. 9 is a diagram for explaining the structure and operation of a neural network model according to other embodiments of the present disclosure;

FIG. 10 is a diagram for explaining a case in which different neural network models are built for different services according to some embodiments of the present disclosure;

FIGS. 11 and 12 are diagrams for further explaining the step of generating error data in FIG. 6;

FIGS. 13 and 14 are diagrams for further explaining the step of determining an anomaly in FIG. 6;

FIG. 15 is a flowchart for explaining an anomaly detection method according to other embodiments of the present disclosure;

FIGS. 16 through 18 are diagrams for further explaining the step of generating response time data in FIG. 15;

FIG. 19 is a diagram for further explaining the step of determining an anomaly in

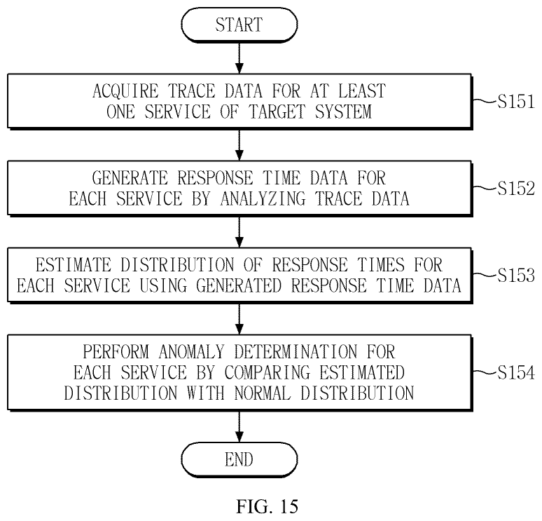

FIG. 15; and

FIG. 20 illustrates an exemplary computing device that can implement the anomaly detection system according to some embodiments of the present disclosure.

### DETAILED DESCRIPTION

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, embodiments of the present disclosure will be described with reference to the attached drawings.

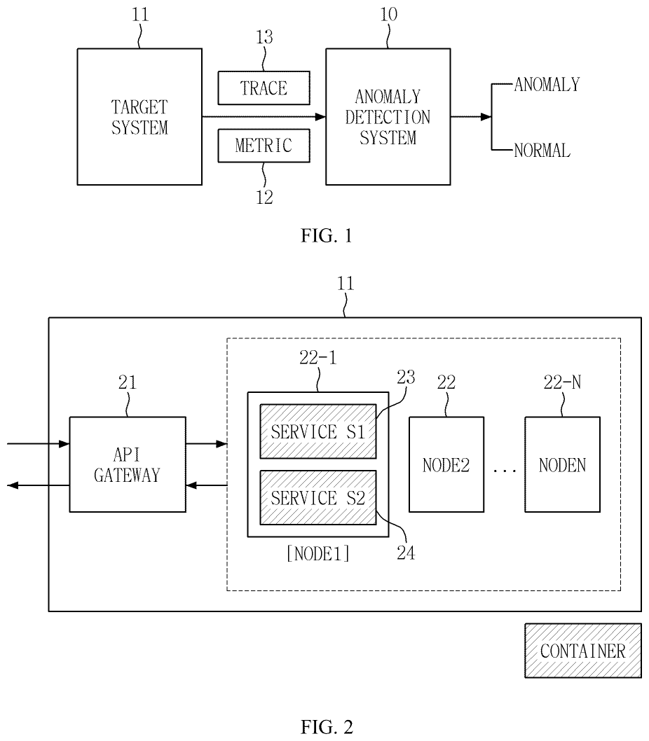

FIG. 1 is a diagram for explaining, at a system level, the operation of an anomaly detection system according to some embodiments of the present disclosure. In FIG. 1 and subsequent figures, the terms “trace data” (e.g., “12”) and “metric data” (e.g., “13”) are simplified as “trace” and “metric,” respectively, for convenience.

Referring to FIG. 1, an anomaly detection system 10 is a computing device or system equipped with an anomaly detection function for a target system 11. For example, the anomaly detection system 10 may analyze metric data 12 and/or trace data 13 of the target system 11 to detect an anomaly, such as a fault or an abnormal operation, in the target system 11.

The term “anomaly” may be interchangeably used with terms such as “abnormality,” “fault,” “error,” “anomaly symptom,” or “anomalous condition/state.”

The target system 11, which is a system subject to anomaly detection, refers to any system that provides the metric data 12 and/or the trace data 13 through a monitoring or logging technique. For example, the target system 11 may be a distributed system that provides both the metric data 12 and the trace data 13, but the present disclosure is not limited thereto. Specifically, the target system 11 may be a microservice architecture-based cloud system, and this will be further explained with reference to FIG. 2. The concept of a microservice architecture, in which detailed system functions are implemented as independent services (i.e., microservices), is already well known in the field to which the present disclosure pertains, and thus, a detailed description thereof will be omitted.

FIG. 2 illustrates a case where the target system 11 is a microservice architecture-based cloud system. In FIG. 2 and subsequent figures and the following description, the term “microservice” may simply be referred to as “service.”

Referring to FIG. 2, the target system 11 may include an application programming interface (API) gateway 21 and a plurality of nodes 22-1 through 22-N. Any arbitrary nodes (e.g., “22-1” or “22-2”) or all the nodes 22-1 through 22-N will be collectively referred to as the nodes 22.

The API gateway 21 is a device or system that forwards a user (client) request to an appropriate node 22 and provides the result of processing the user request to a user (i.e., a client terminal). The role of the API gateway 21 is already well known in the field to which the present disclosure pertains, and thus, a detailed description thereof will be omitted.

Thereafter, the nodes 22 are physical servers that provide cloud services based on a microservice architecture. In each of the nodes 22, at least one container (e.g., “23” or “24”) may be driven, and each container (e.g., “23” or “24”) may independently provide or execute a service (e.g., “S1” or “S2”), but the present disclosure is not limited thereto.

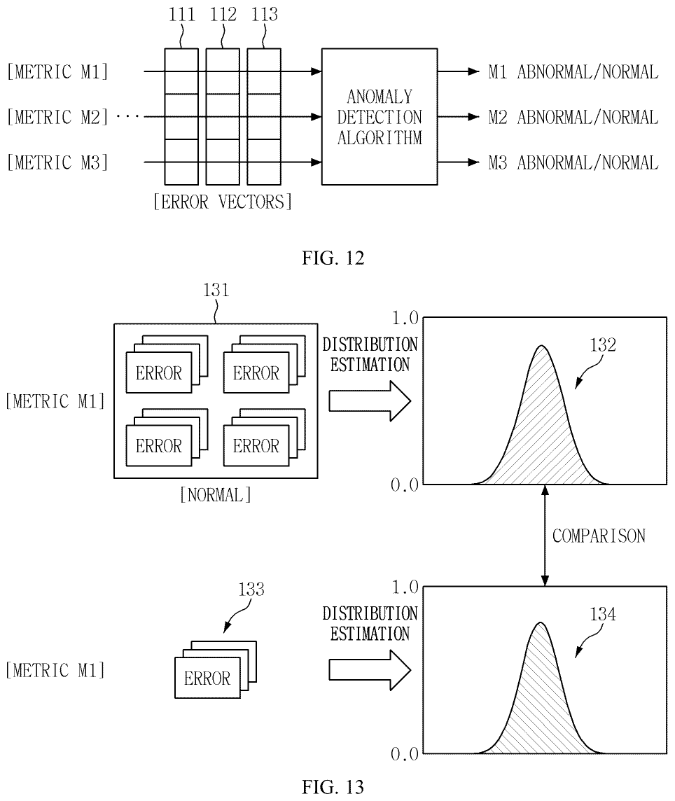

In this case, the target system 11 may measure and provide predefined metrics (e.g., performance metrics) for each container or service, as illustrated in FIG. 12. Additionally, the target system 11 may provide the trace data 13, which records the process of user requests being handled.

Referring back to FIG. 1, the metric data 12 refers to data related to at least one metric (e.g., time-series data) measured from the target system 11. For example, the metric data 12 may include measurement values (or observed values) for a plurality of metrics at a specific time point/period. Examples of the metrics include central processing unit (CPU) usage, memory usage, and the like, but the present disclosure is not limited thereto.

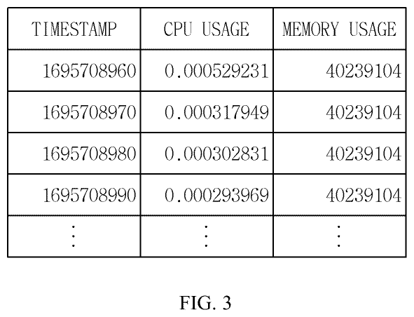

FIG. 3 illustrates an example of the metric data 12.

Referring to FIG. 3, the metric data 12 may be multivariate time-series data that comprises measurement values for a plurality of metrics (e.g., CPU usage and memory usage). In the metric data 12, metric values at a specific time point/period may also be referred to as “metric records” or “metric data instances.”

When the target system 11 is a microservice architecture-based system, as illustrated in FIG. 2, the metric data 12 may exist for each service. The anomaly detection system 10 may perform anomaly detection for each service using its corresponding metric data 12.

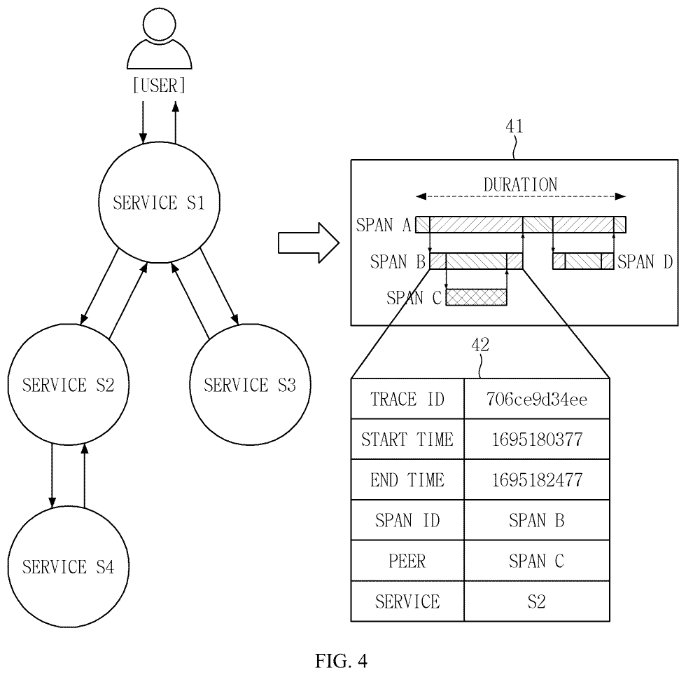

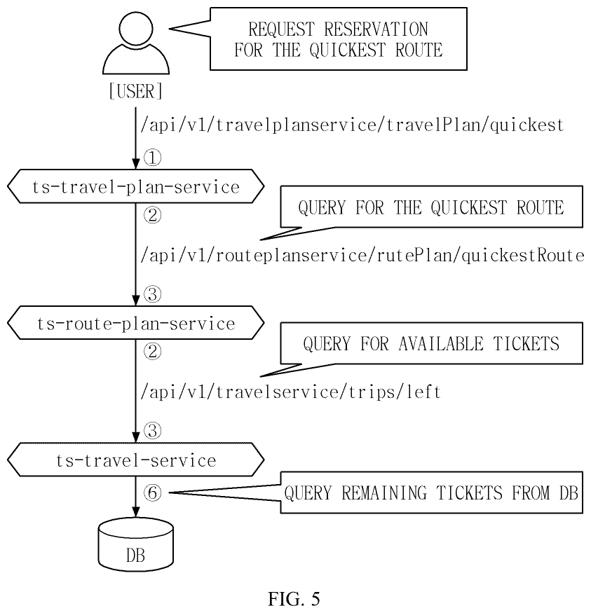

Referring back to FIG. 1, the trace data 13 refers to data generated by tracking and recording the process of the target system 11 handling user requests. The trace data 13 may include one or more trace records (or traces), and each trace record may correspond to a single user request. A trace record may include, for example, the call relationship between services and detailed information on a task processed within each service, as referenced in FIG. 4, but the present disclosure is not limited thereto. For better understanding, the trace data 13 will be briefly explained with reference to FIGS. 4 and 5.

FIGS. 4 and 5 are diagrams for explaining trace data and a trace record that may be referenced in various embodiments of the present disclosure.

Referring to FIG. 4, it is assumed that a user request is processed through four services S1 through S4. An example of a user request being processed through services is illustrated in FIG. 5. FIG. 5 depicts a case where a train ticket reservation request for a shortest route is processed through three services.

Referring again to FIG. 4, when a user request is processed through the four services S1 through S4, a trace record 41, as shown on the right side, may be generated. The trace record 41 may include a plurality of span records (e.g., “42”), and each of the span records may contain detailed task information regarding a task processed in a specific service. For example, the span record 42 corresponding to span B may include detailed task information regarding a task processed in the service S2. Examples of such detailed task information include a trace ID, task start time, task end time, span ID, and related service, but the present disclosure is not limited thereto.

The duration (or length) of a span refers to the amount of time taken to process a task and may be calculated as the difference between the task's end time and start time. Additionally, in the call structure (e.g., a tree structure) for services, the duration of a span corresponding to a higher-level service, such as span A corresponding to the service S1, may include the duration of a span corresponding to a lower-level service, such as span B corresponding to the service S2. In the following description, spans corresponding to a higher-level service and a lower-level service may be referred to as a “parent span” and a “child span,” respectively.

Traces, which are a type of log generated in a distributed system, are already well known in the field to which the present disclosure pertains, and thus, a detailed description thereof will be omitted.

Referring back to FIG. 1, the specific method by which the anomaly detection system 10 detects anomalies in the target system 11 may vary depending on the embodiment.

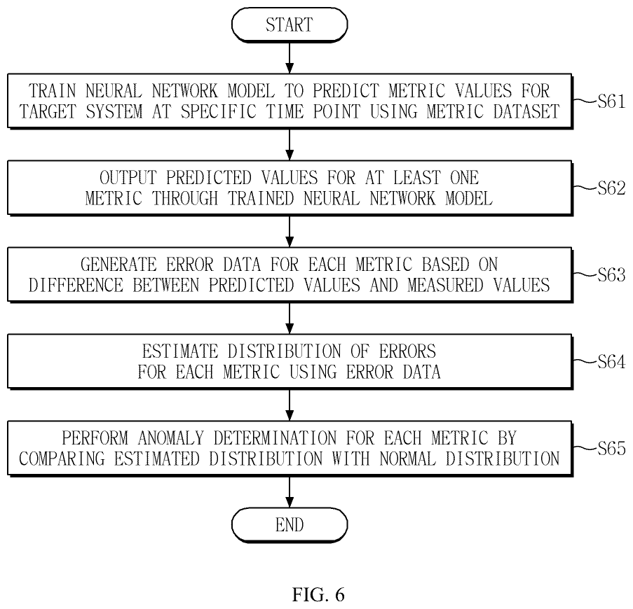

In some embodiments, the anomaly detection system 10 may predict a value for a specific metric for an arbitrary time point/period (i.e., an anomaly detection time/period) and generate error data for the specific metric based on the difference between the predicted value and a measured value, using a neural network model configured to predict a metric value for a specific time point. The anomaly detection system 10 may then estimate the distribution of errors for the specific metric from the error data and compare the estimated distribution with a normal distribution to perform anomaly determination for the specific metric. Here, the normal distribution refers to a distribution derived (or estimated) from error data obtained when the target system 11 operates normally. In this manner, any anomaly in the target system 11 can be accurately detected. The details of these embodiments will be further explained later with reference to FIGS. 6 through 14.

In other embodiments, the anomaly detection system 10 may generate response time data for a specific service (or a service module such as a container) in the target system 11 by analyzing the trace data 13. The anomaly detection system 10 may then estimate the distribution of response times for the specific service based on the response time data and compare the estimated distribution with a normal distribution to determine whether an anomaly has occurred in the specific service. Here, the normal distribution refers to a distribution derived (or estimated) from response time data obtained when the specific service operates normally. In this manner, any anomaly in the target system 11 can be accurately detected on a service-by-service basis. The details of these embodiments will be further explained later with reference to FIGS. 15 through 19.

In yet other embodiments, an anomaly in the target system 11 may be detected based on various combinations of the aforementioned embodiments. For example, the anomaly detection system 10 may detect an anomaly in the target system 11 by comprehensively analyzing both a first anomaly detection result obtained from the analysis of the metric data 12 and a second anomaly detection result obtained from the analysis of the trace data 13.

The anomaly detection system 10 may be implemented using at least one computing device. For example, all functionalities of the anomaly detection system 10 may be implemented in a single computing device, or a first function of the anomaly detection system 10 may be implemented in a first computing device while a second function of the anomaly detection system 10 is implemented in a second computing device. Alternatively, a specific function of the anomaly detection system 10 may be implemented across multiple computing devices.

Here, the term “computing device” may include any device equipped with computing capabilities. An exemplary computing device is illustrated in FIG. 20. Since a computing device is an aggregate of various components, such as memories and processors, that interact with one another, it may sometimes be referred to as a “computing system.” The term “computing system” may also encompass a concept in which multiple computing devices interact with one another.

Thus far, the operation of the anomaly detection system 10 according to some embodiments of the present disclosure has been briefly explained with reference to FIGS. 1 through 5. Various methods that may be performed by the anomaly detection system 10 will hereinafter be described with reference to FIG. 6 and subsequent figures.

For the sake of clarity, the following description assumes that all steps and operations of the methods to be described below are performed by the anomaly detection system 10. Therefore, when a specific step or operation does not explicitly specify a responsible entity, it is to be understood that the specific step or operation is performed by the anomaly detection system 10. However, in actual environments, some steps or operations of the methods to be described below may be performed by other computing devices.

Additionally, for convenience, the anomaly detection system 10 will be abbreviated as the system 10.

FIG. 6 is a flowchart for explaining an anomaly detection method according to some embodiments of the present disclosure. However, this is merely an exemplary embodiment for achieving the objectives of the present disclosure, and certain steps may be added or omitted as needed.

Referring to FIG. 6, the present embodiment relates to a method for detecting an anomaly in the target system 11 using metric data.

Specifically, the anomaly detection method according to some embodiments of the present disclosure may begin with step S61, which involves training a neural network model to predict a metric value for a specific time point/period for the target system 11 using a metric dataset. For example, the system 10 may train the neural network model using a normal metric dataset of the target system 11. Here, the normal metric dataset may include a dataset with a high proportion of normal metric data. The normal metric dataset may be generated, for example, by collecting metric data when the target system 11 operates normally, but the present disclosure is not limited thereto.

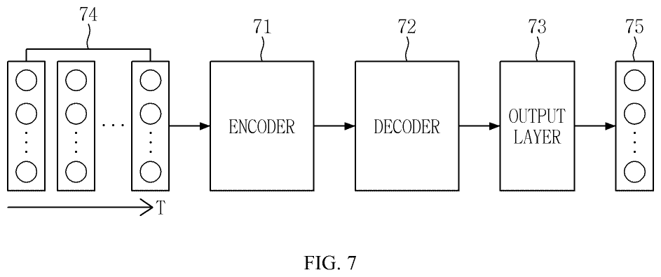

The structure and training method of a neural network model will hereinafter be described with reference to FIGS. 7 through 10.

FIG. 7 is a diagram for explaining the structure and operation of a neural network model according to some embodiments of the present disclosure.

Referring to FIG. 7, the neural network model may include an encoder 71, a decoder 72, and an output layer 73. However, in some embodiments, the decoder 72 may also serve the function of the output layer 73, or the neural network model may be configured without the decoder 72.

The encoder 71 is a neural network module that encodes input metric data 74. For example, the encoder 71 may be configured to receive and encode the input metric data 74, which comprises metric records from multiple time points. In this case, the encoder 71 performs encoding, comprehensively considering the temporal relationship between metric values and the correlation between metrics. As mentioned above, a metric record refers to metric data for a specific time point/period and may include a measured value for at least one metric.

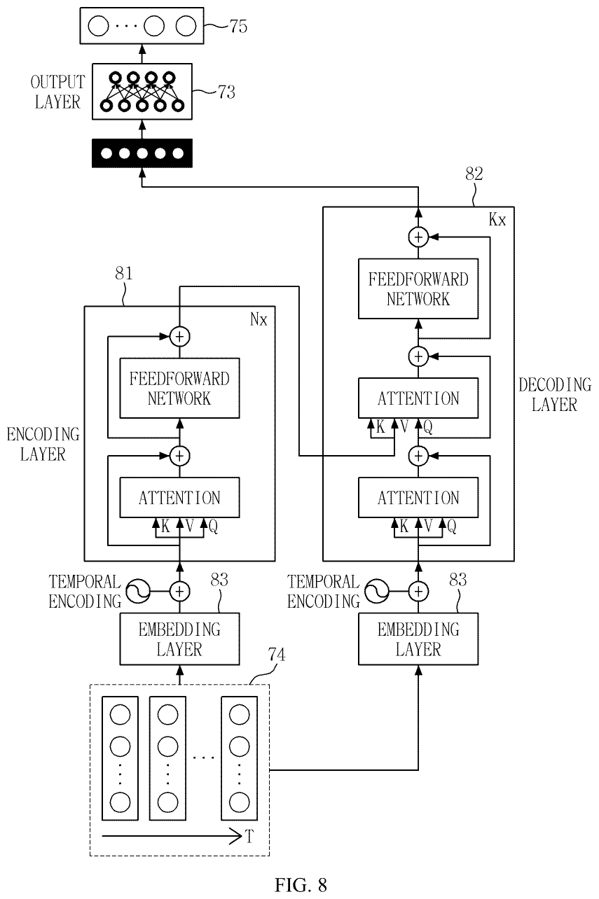

The encoder 71 may be implemented using various types of neural networks. For example, the encoder 71 may be implemented using a neural network suitable for sequence data (or time-series data), such as a transformer (e.g., a transformer encoder), as referenced in FIG. 8, but the present disclosure is not limited thereto.

The decoder 72 is a neural network module that decodes data output from the encoder 71 (e.g., encoded/embedded vectors).

The decoder 72 may also be implemented using various types of neural networks. For example, the decoder 72 may be implemented using a neural network suitable for sequence data (or time-series data), such as a transformer (e.g., a transformer decoder), as referenced in FIG. 8, but the present disclosure is not limited thereto.

The output layer 73 is a neural network module that predicts and outputs metric data 75 for a specific time point/period based on the data output from the decoder 72. For example, the output layer 73 may be configured to output (or predict) metric data 75 for a future time point relative to the input metric data 74 input into the encoder 71. Alternatively, the output layer 73 may be configured to output (or predict) metric data 75 for the same time point as, or a similar time point to, the input metric data 74 (e.g., a time point within the input metric data 74). The metric data 75 may be a metric record for a specific time point or may include multiple metric records for different time points.

The output layer 73 may be implemented based on, for example, a fully connected layer, but the present disclosure is not limited thereto.

FIG. 8 illustrates an exemplary detailed structure of the neural network model according to some embodiments of the present disclosure. Specifically, FIG. 8 illustrates a case where the neural network model of FIG. 7 is implemented based on a transformer.

Referring to FIG. 8, the encoder 71 may include N encoding layers 81 (where N is a natural number equal to or greater than 1), and each of the N encoding layers 81 may be implemented based on a transformer encoder.

Additionally, the decoder 72 may include K decoding layers 82 (where K is a natural number equal to or greater than 1), and each of the K decoding layers 82 may be implemented based on a transformer decoder.

The detailed structure and operational principles of transformer encoders and transformer decoders are already well known in the field to which the present disclosure pertains, and thus, detailed descriptions thereof will be omitted.

The input metric data 74 may be embedded through an embedding layer 83 and then input into the encoding layers 81 and the decoding layers 82. To transmit time (or temporal) information of metric records constituting the input metric data 74 to each encoding layer 81 and decoding layer 82, temporal encoding information may be reflected in the result of the embedding of the input metric data 74.

The embedding layer 83 may be implemented based on, for example, a fully connected layer, but the present disclosure is not limited thereto.

The aforementioned neural network model may be trained in an unsupervised or semi-supervised manner based on a normal metric dataset. Specifically, the system 10 may input normal metric data into the neural network model, compute a task loss by performing a predefined task, and update the parameters of the neural network model based on the computed task loss. The system 10 may repeat this process for other normal metric data to train the neural network model.

However, the type of task used for training the neural network model may vary.

In some embodiments, the neural network model may be trained through a task that predicts a future metric value based on input metric data. For example, the system 10 may input normal metric data (e.g., multiple normal metric records for different time points) into the neural network model, predict metric data for a future time point, and compute a prediction loss based on the difference between a measured value (i.e., ground truth) and a predicted value (i.e., the predicted metric data) for the future time point. The system 10 may then update the neural network model based on the computed prediction loss.

In other embodiments, the neural network model may be trained through a task that reconstructs at least some metric values of the input metric data. For example, the system 10 may perform a task to reconstruct a normal metric data record for a specific time point through the neural network model and compute a reconstruction loss. Alternatively, the system 10 may input data that comprises multiple normal metric records for different time points into the neural network model and perform a task to reconstruct the normal metric record for the specific time point, thereby computing a reconstruction loss. The system 10 may then update the neural network model based on the computed reconstruction loss.

In yet other embodiments, the neural network model may be trained based on various combinations of the aforementioned embodiments. For example, the system 10 may compute a first task loss by performing a first task of predicting a future metric value through a first output layer, and compute a second task loss by performing a second task of reconstructing a metric value for a specific time point through a second output layer (e.g., when the neural network model includes an encoder, a decoder, and two output layers). The system 10 may then update the neural network model based on the first and second task losses.

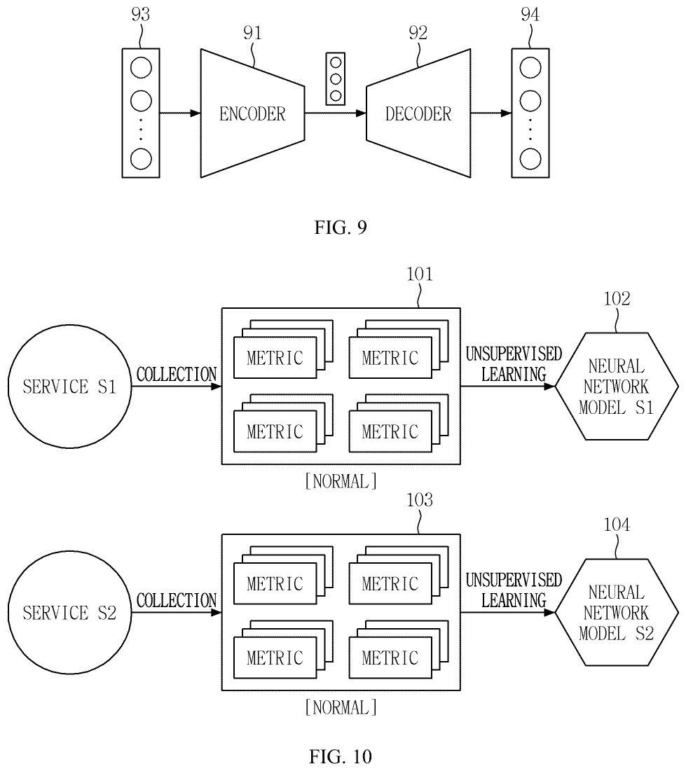

Thus far, the structure and training method of the neural network model according to some embodiments of the present disclosure have been described with reference to FIGS. 7 and 8. The structure and training method of a neural network model according to other embodiments of the present disclosure will hereinafter be described with reference to FIG. 9.

FIG. 9 illustrates the structure of a neural network model according to other embodiments of the present disclosure.

Referring to FIG. 9, the neural network model may be configured as an autoencoder. In other words, the neural network model may include an encoder 91 and a decoder 92.

The encoder 91 is a neural network module that encodes input metric data 93. The input metric data 93 may include either a single metric record or multiple metric records.

The decoder 92 is a neural network module that decodes data output from the encoder 91 (e.g., encoded/embedded vectors) to reconstruct the input metric data 93.

The encoder 91 and the decoder 92 may be implemented using any type of neural network.

The neural network model may be trained through a task of reconstructing the input metric data 93. The training of the neural network model (e.g., an autoencoder) based on a reconstruction loss is already well known in the field to which the present disclosure pertains, and thus, a detailed description thereof will be omitted.

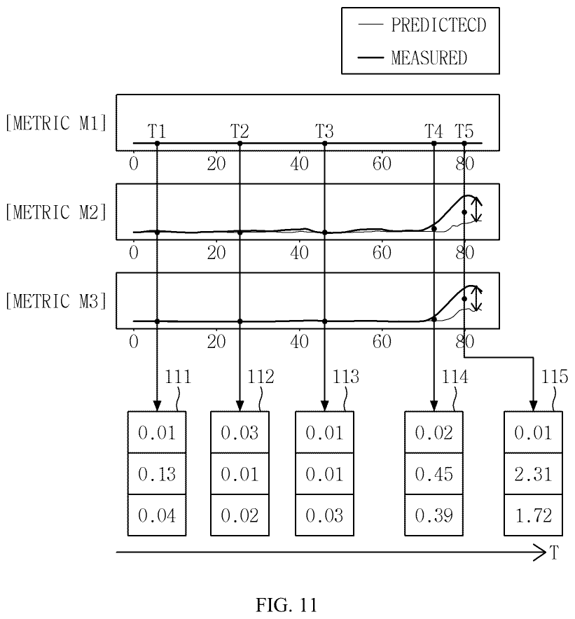

Meanwhile, in some embodiments, a neural network model (e.g., the neural network models in FIGS. 7 through 9) may be built separately for each service of the target system 11 to improve the prediction/reconstruction performance of the neural network model by accounting for differences in metric patterns (e.g., anomaly patterns or normal patterns) across services. For example, referring to FIG. 10, in a case where the target system 11 processes a user request through two services S1 and S2, a neural network model 102 may be built (or trained) using a normal metric dataset 101 of the service S1, and another neural network model 104 may be built (or trained) using a normal metric dataset 103 of the service S2. In FIG. 10, the neural network models 102 and 104 are marked with their corresponding service symbols, i.e., S1 and S2, respectively. Then, the system 10 may perform anomaly detection for the service S1 by predicting a metric value for the service S1 using the neural network model 102, and perform anomaly detection for the service S2 by predicting a metric value for the service S2 using the neural network model 104.

Referring again to FIG. 6, steps S62 through S65 to be described below relate to the detailed process of detecting an anomaly in the target system 11 using a trained neural network model.

In step S62, the trained neural network model outputs predicted values for at least one metric. For example, the system 10 may output predicted values for multiple metrics by inputting metric data received (e.g., metric records for multiple time points, received in real time) from the target system 11 into the trained neural network model. The predicted values for the multiple metrics represent predicted values for an anomaly detection time point (or period). The anomaly detection time point may or may not be a future time point relative to the input metric data, as mentioned earlier with reference to FIGS. 7 through 9.

If neural network models are built separately for respective services, as mentioned earlier with reference to FIG. 10, the system 10 may output predicted values for at least one metric by inputting metric data of each service into a corresponding neural network model.

In step S63, error data for each metric is generated based on the differences between the predicted values and respective measured values. Here, the measured values refer to metric values for the same time point as the predicted values.

For example, referring to FIG. 11, in a case where the trained neural network model outputs predicted values for three metrics M1 through M3, the system 10 may generate an error vector 111 for a time point T1 based on the differences between the measured values and predicted values for the time point T1. Similarly, error vectors 112 through 115 may be generated for time points T2 through T5, respectively. The elements of each error vector (e.g., “111”) may be understood as the error values for the respective metrics. Then, the system 10 may extract the error values for each metric from the error vectors 111 through 115 and generate error data for each metric. For example, referring to FIG. 12, the system 10 may generate error data for the metric M1 by extracting error values for the metric M1 from the error vectors 111 through 113 and may perform anomaly detection for the metric M1 using the generated error data. The system 10 may also generate error data for the other metrics M2 and M3 in the same manner. Each piece of error data may consist of a single error value (e.g., an error value for a specific time point) or multiple error values (e.g., error values for multiple time points within a specific period).

It is to be understood that errors in predicted values for one or more metrics are calculated because it contains information useful for anomaly detection. In other words, in the case of a neural network model trained with a normal metric dataset, the errors in the predicted metric values become greater as the measured values for the same time point become more anomalous (because the neural network model is trained to predict metric values in a normal state, as indicated by the error vector 115). Therefore, instead of using the measured metric values directly, anomaly detection is performed based on the errors in the predicted values obtained through the neural network model.

Referring back to FIG. 6, in step S64, the distribution (i.e., probability distribution) of errors for each metric is estimated using the error data. For example, the system 10 may estimate the distribution (i.e., probability distribution) of errors for a specific metric using its error data. The system 10 may also estimate the distributions of errors for other metrics in the same manner.

The distribution of errors for each metric may be estimated using, for example, a kernel density estimation (KDE) method, but the present disclosure is not limited thereto. The KDE method is already well known in the field to which the present disclosure pertains, and thus, a detailed description thereof will be omitted.

For reference, the bandwidth of a kernel function is a hyperparameter for adjusting the shape of the kernel function graph to be sharper or smoother, and may be pre-determined using various bandwidth selection techniques (e.g., cross-validation, plug-in methods, etc.).

In step S65, anomaly detection for each metric is performed by comparing the estimated distribution with a normal distribution. Here, the normal distribution refers to a distribution derived (or estimated) from error data obtained when the target system 11 operates normally. For example, the system 10 may perform anomaly detection for a specific metric by comparing its estimated distribution (i.e., its estimated error distribution) with its normal distribution. In other words, the system 10 may determine whether the measured values for the specific metric are outliers, and detect an anomaly occurring in the target system 11 (e.g., in a specific service) based on the result of the determination. Additionally, the system 10 may also perform anomaly detection for other metrics in the same manner.

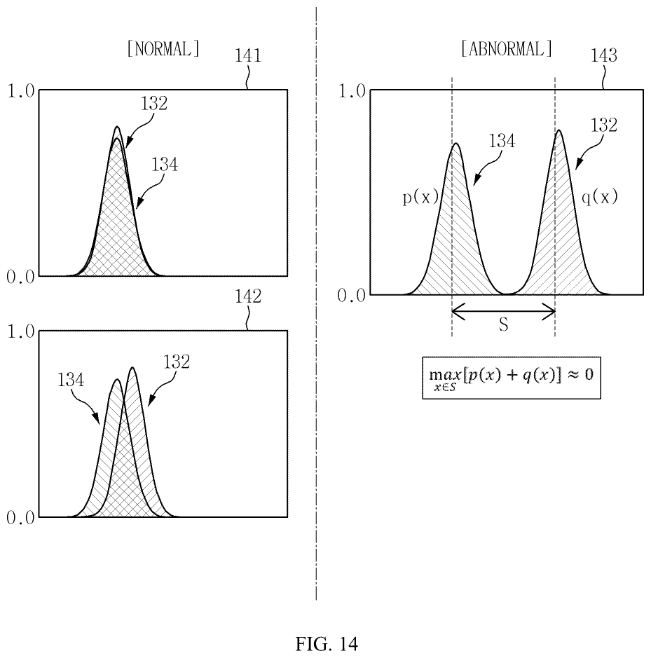

The detailed process of performing anomaly detection for a specific metric in step S65 will hereinafter be described with reference to FIGS. 13 and 14. This anomaly detection process can also be applied as-is to an anomaly detection method that will be described later with reference to FIGS. 15 through 19 (i.e., this anomaly detection process can be equally applied to determining an anomaly by comparing the estimated and normal distributions of service response times).

FIGS. 13 and 14 are diagrams for further explaining step S65 in FIG. 6. FIGS. 13 and 14 illustrate, as an example, the process of performing anomaly determination for the metric M1.

Referring to FIG. 13, the system 10 may determine whether an anomaly exists in the metric M1 by comparing an estimated error distribution 134 for the metric M1 with a normal error distribution 132 for the metric M1. As described above, the normal error distribution 132 refers to a distribution derived (or estimated) from error data 131 (or an error dataset) obtained when the target system 11 operates normally (e.g., a distribution derived using the KDE method). Meanwhile, the estimated error distribution 134 refers to a distribution estimated based on error data 133 generated in step S63 described above.

Referring to FIG. 14, the system 10 may determine the presence of an anomaly based on the degree of overlap between the estimated error distribution 134 and the normal error distribution 132 (e.g., by determining whether the measured values for the metric M1 are outliers). For example, if no overlap (or almost no overlap) exists between the estimated error distribution 134 and the normal error distribution 132, the system 10 may determine that an anomaly has occurred in the target system 11 (i.e., the measured values for the metric M1 are outliers, as indicated by reference numeral 143). Conversely, if there exists an overlapping region between the estimated error distribution 134 and the normal error distribution 132, the system 10 may determine that the target system 11 operates normally, as indicated by reference numerals 141 and 142. This approach eliminates the need to set a threshold for anomaly detection and provides the advantage of not requiring an administrator with specialized knowledge.

However, the method to determine the degree of overlap (or to compare the estimated error distribution 134 with the normal error distribution 132) may vary.

In some embodiments, the degree of overlap may be determined using the values within a section S between the estimated error distribution 134 and the normal error distribution 132. For example, the system 10 may determine a first representative value (e.g., mode, median, etc.) of the estimated error distribution 134 and a second representative value of the normal error distribution 132. Then, the system 10 may calculate the sum of probability values p (x) and q (x) according to the estimated error distribution 134 and the normal error distribution 132 for each of the values within the section S between the first and second representative values. The system 10 may then determine the degree of overlap by comparing the maximum of the calculated sums with zero. For example, if the maximum of the calculated sums is zero or close to zero, the system 10 may determine that no overlap (or almost no overlap) exists between the estimated error distribution 134 and the normal error distribution 132, as indicated by the equation in FIG. 14. Alternatively, if the maximum of the calculated sums is zero or close to zero, the system 10 may determine that an anomaly has occurred in the target system 11 (i.e., the measured values for the metric M1 are outliers).

In other embodiments, the degree of overlap between the estimated error distribution 134 and the normal error distribution 132 may be determined based on Kullback-Leibler (KL) divergence. For example, if the KL divergence between the estimated error distribution 134 and the normal error distribution 132 approaches infinity, the system 10 may determine that the estimated error distribution 134 and the normal error distribution 132 do not overlap (i.e., no overlapping region exists between the estimated error distribution 134 and the normal error distribution 132) or that an anomaly has occurred in the target system 11 (i.e., the measured values for the metric M1 are outliers).

In yet other embodiments, the degree of overlap between the estimated error distribution 134 and the normal error distribution 132 may be determined based on Jensen-Shannon (JS) divergence. For example, if the JS divergence value between the estimated error distribution 134 and the normal error distribution 132 is approximately log 2, the system 10 may determine that the estimated error distribution 134 and the normal error distribution 132 do not overlap (i.e., no overlapping region exists between the estimated error distribution 134 and the normal error distribution 132) or that an anomaly has occurred in the target system 11 (i.e., the measured values for the metric M1 are outliers).

In yet other embodiments, the degree of overlap between the estimated error distribution 134 and the normal error distribution 132 may be determined based on various combinations of the aforementioned embodiments.

In some embodiments, the normal error distribution 132 for the metric M1 may be continuously updated. For example, the system 10 may derive a new normal error distribution 132 for the metric M1 using recent error data for the metric M1 (only in the case of normalcy) or other error data obtained when the target system 11 operates normally. Through this update process, the system 10 can easily adapt to changes in anomaly patterns in the target system 11, thereby maintaining a high level of anomaly detection accuracy over time.

Additionally, in some embodiments, the bandwidth of the kernel function may be adjusted based on the accuracy of the results of anomaly detection. For example, if a false positive (FP) occurs, the system 10 may decrease the bandwidth of the kernel function, in which case, the shape of the graph of the probability distribution becomes sharper. As a result, the degree of overlap between the estimated error distribution 134 and the normal error distribution 132 is assessed more strictly, thereby reducing the rate of FPs. Conversely, if a false negative (FN) occurs, the system 10 may increase the bandwidth of the kernel function, in which case, the shape of the graph of the probability distribution becomes smoother. As a result, the degree of overlap between the estimated error distribution 134 and the normal error distribution 132 is assessed less strictly, thereby reducing the rate of FNs. When the bandwidth of the kernel function is adjusted, the system 10 may derive a new normal error distribution 132 accordingly. The technical details of the present embodiment may also be applicable to the anomaly detection method to be described with reference to FIGS. 15 through 19.

Thus far, the anomaly detection method according to some embodiments of the present disclosure has been described with reference to FIGS. 6 through 14. As explained above, predicted values for a specific metric can be obtained via a neural network model trained with a normal metric dataset, and the distribution of errors in the predicted values can be estimated from error data. By comparing the estimated error distribution with a normal error distribution, any anomaly in the specific metric can be accurately determined, enabling an accurate detection of an anomaly in the target system 11.

Additionally, since anomaly determination is performed based on whether an overlapping region exists between the estimated error distribution and the normal error distribution, there is no need to set a threshold. Consequently, various issues associated with threshold-based anomaly detection (e.g., the inconvenience of setting a threshold, the likelihood of anomaly detection accuracy being significantly affected by the set threshold, the requirement for a specialized administrator, the need for continuous threshold adjustments, and the like) can be easily resolved.

Furthermore, by continuously updating the normal error distribution, the problem of anomaly detection accuracy decreasing due to changes in anomaly patterns in the target system 11 can also be effectively addressed.

An anomaly detection method according to other embodiments of the present disclosure will hereinafter be described with reference to FIGS. 15 through 19.

For ease of understanding, the following description assumes that the target system 11 is a microservice architecture-based system as illustrated in FIG. 2.

FIG. 15 is a flowchart for explaining an anomaly detection method according to other embodiments of the present disclosure. However, this is merely an exemplary embodiment for achieving the objectives of the present disclosure, and certain steps may be added or omitted as needed.

Referring to FIG. 15, the present embodiment relates to a method for detecting an anomaly in the target system 11 using trace data.

Specifically, the anomaly detection method according to other embodiments of the present disclosure may begin with step S151, in which trace data for at least one service of the target system 11 is acquired. For example, the system 10 may receive trace data from the target system 11 in real time. As described above, the trace data may include multiple trace records, and each of the multiple trace records may correspond to a single user request.

In step S152, response time data for each service is generated by analyzing the trace data. For example, the system 10 may calculate response times for a specific service by analyzing the duration of a span associated with the specific service in each of the multiple trace records. The system 10 may then generate response time data based on a representative value of the calculated response times. The system 10 may also generate response time data for other services in the same manner.

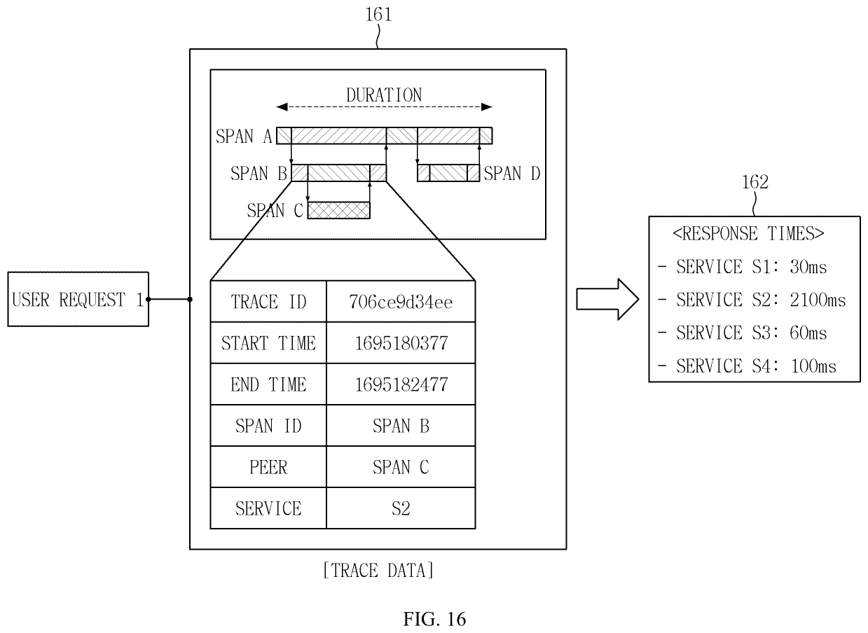

For better understanding, the details of step S152 will be further explained with reference to FIGS. 16 through 18.

FIGS. 16 through 18 illustrate the process of generating response time data for each service. FIGS. 16 through 18 assume that the target system 11 processes a user request through four services S1 through S4 with spans A through D corresponding to the services S1 through S4, respectively, as shown in FIG. 4.

Referring to FIG. 16, the system 10 may calculate a response time 162 for each of the services S1 through S4 based on the span duration in a trace record 161. For example, the system 10 may use the duration of each span (e.g., span A or B) as the response time for the corresponding service (e.g., the service S1 or S2). Alternatively, the system 10 may determine the response time for the service S1 by subtracting, from the duration of span A, the durations of the child spans of span A, i.e., spans B and D. The system 10 may also calculate the response times for the other services (e.g., the service S2) in a similar manner.

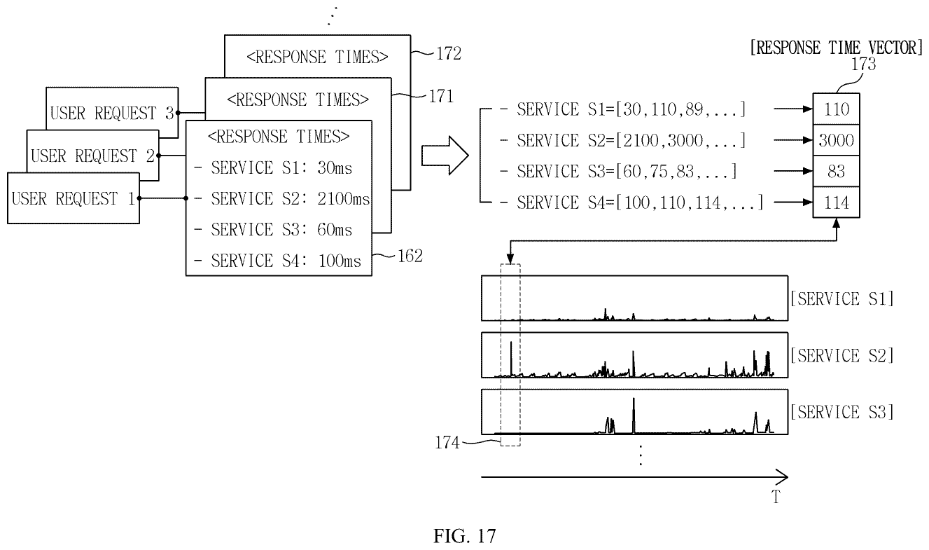

Referring to FIG. 17, the system 10 may calculate the response times for the services S1 through S4 by analyzing the span durations in other trace records. As a result, multiple (or one or more) response times 171 and 172 may be produced for each service. The number of response times may vary from one service to another (since the number of services used may differ from one user request to another) or may be the same (e.g., the number of response times for the service S1 may or may not be the same as the number of response times for the service S2).

Thereafter, as illustrated in FIG. 17, the system 10 may determine a representative response time for each service (e.g., the service S1 or S2) based on the response times 162, 171, and 172 for each service and generate a response time vector 173. The elements of the response time vector 173 may be understood as the representative response times of the respective services. Additionally, this process may be understood as determining a representative response time for each service within a specific section (or time period) 174 while ensuring that the number of response times within the section 174 is the same across the services S1 through S4 (e.g., the response time vector 173 may be generated by analyzing the trace records within the section 174).

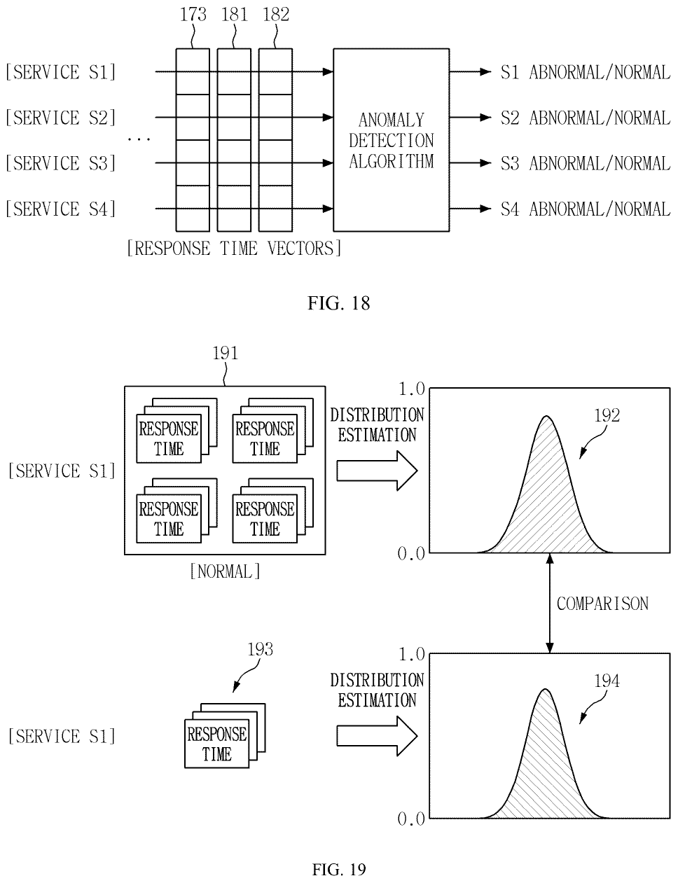

Thereafter, referring to FIG. 18, the system 10 may extract multiple representative response times for each service (e.g., the service S1 or S2) from multiple response time vectors 173, 181, and 182, thereby generating response time data for the corresponding service. For example, the system 10 may generate response time data for the service S1 by extracting representative response times for the service S1 from the response time vectors 173, 181, and 182, and use the generated response time data for anomaly detection for the service S1. The system 10 may generate response time data for the other services (e.g., the service S2) in the same manner. The response time data may consist of a single or multiple representative response times.

However, the method to determine a representative response time may vary.

Specifically, in some embodiments, the representative response time for, for example, the service S1, may be determined based on the service S1's response times greater than the median (e.g., response times in the outer quantile ranges). For example, the system 10 may determine the representative response time for the service S1 as a value above the 60^{th} (or 70^{th} or 80^{th}) quantile. In this manner, the accuracy of anomaly detection for each service (e.g., the service S1) may be improved, as response times in the outer quantiles tend to reflect anomalies more effectively.

In other embodiments, the representative response time for each service may be determined based on different statistical measures (e.g., mean, mode, median, and the like).

Referring back to FIG. 15, in step S153, the distribution of response times for each service is estimated using the response time data. For example, the system 10 may estimate the response time distribution for each service using the KDE method. Further details of step S153 are provided in the description of step S64.

In step S154, anomaly determination is performed for each service by comparing the estimated distribution for each service with a normal distribution (i.e., a service-specific normal distribution). Here, the normal distribution refers to a distribution derived (or estimated) from response time data obtained when each service of the target system 11 operates normally.

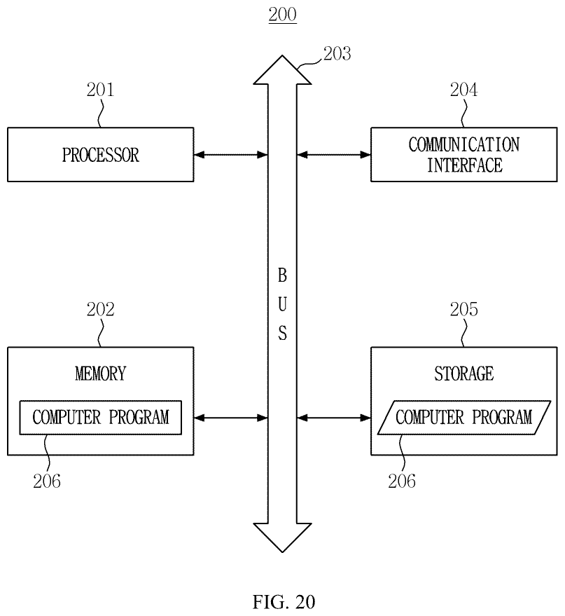

For example, referring to FIG. 19, the system 10 may determine whether an anomaly exists in the service S1 by comparing an estimated response time distribution 194 with a normal response time distribution 192. As described above, the normal response time distribution 192 refers to a distribution derived (or estimated) from normal response time data 191 obtained when the service S1 operates normally (e.g., a distribution derived using the KDE method). Meanwhile, the estimated response time distribution 194 refers to a distribution estimated based on response time data 193 generated in step S152. Specifically, the system 10 may determine whether an anomaly exists in the service S1 based on the degree of overlap between the estimated response time distribution 194 and the normal response time distribution 192. For example, if no overlap (or almost no overlap) exists between the estimated response time distribution 194 and the normal response time distribution 192, the system 10 may determine that an anomaly has occurred in the service S1. Further details of this anomaly determination method are provided in the description of FIG. 14.

Further details of step S154 are provided in the description of step S65.

Thus far, the anomaly detection method according to other embodiments of the present disclosure has been described with reference to FIGS. 15 through 19. As described above, response time data for a specific service may be generated by analyzing trace data, and the response time distribution for the specific service may be estimated from the response time data. Then, by comparing the estimated distribution with a normal distribution, an accurate anomaly determination can be performed for the service.

Additionally, since anomaly determination is performed based on whether an overlapping region exists between the estimated distribution and the normal distribution, there is no need to set a threshold. Consequently, various issues associated with threshold-based anomaly detection (e.g., the inconvenience of setting a threshold, the likelihood of anomaly detection accuracy being significantly affected by the set threshold, the requirement for a specialized administrator, and the need for continuous threshold adjustments) can be easily resolved.

An exemplary computing device 200 capable of implementing the system 10 according to some embodiments of the present disclosure will hereinafter be described with reference to FIG. 20.

FIG. 20 is a diagram illustrating the hardware configuration of the computing device 200.

Referring to FIG. 20, the computing device 200 may include at least one processor 201, a bus 203, a communication interface 204, a memory 202 that loads a computer program 206 executed by the processor 201, and a storage 205 that stores the computer program 206. However, FIG. 20 illustrates only the components relevant to the embodiments of the present disclosure. Therefore, those skilled in the art will recognize that the computing device 200 may include additional general-purpose components beyond those illustrated in FIG. 20. In other words, the computing device 200 may further include various additional components beyond those illustrated in FIG. 20. Additionally, the computing device 200 may be configured with some of the components illustrated in FIG. 20 omitted. The components of the computing device 200 will be described below.

The processor 201 may control the overall operation of the computing device 200. The processor 201 may include at least one of a central processing unit (CPU), a microprocessor unit (MPU), a microcontroller unit (MCU), a graphics processing unit (GPU), or any other processor type well known in the relevant technical field of the present disclosure. The processor 201 may also perform computations for at least one application or computer program to execute specific steps/operations/methods. The computing device 200 may include one or more processors.

The memory 202 may store various data, commands, and/or information. The memory 202 may load the computer program 206 from the storage 205 to execute the specific steps/operations/methods. The memory 202 may be implemented as a volatile memory, such as random-access memory (RAM), but the present disclosure is not limited thereto.

The bus 203 may facilitate communication between the components of the computing device 200. The bus 203 may be implemented using various types of buses, such as an address bus, a data bus, or a control bus.

The communication interface 204 may support wired or wireless Internet communication for the computing device 200. Additionally, the communication interface 204 may support various other communication methods beyond Internet communication. To this end, the communication interface 204 may include a communication module well known in the relevant technical field of the present disclosure.

The storage 205 may non-transitorily store at least one computer program 206. The storage 205 may include a non-volatile memory such as read-only memory (ROM), erasable programmable ROM (EPROM), electrically erasable programmable ROM (EEPROM), flash memory, a hard disk, a removable disk, or any computer-readable recording medium well known in the relevant technical field of the present disclosure.

The computer program 206 may include instructions that, when loaded into the memory 202, cause the processor 201 to perform the specific steps/operations/methods. In other words, the processor 201 may execute the instructions loaded into the memory 202 to perform the specific steps/operations/methods.

For example, the computer program 206 may include instructions for performing the operations of: acquiring a neural network model configured to predict a metric value for a specific time point for the target system 11; outputting predicted values for a specific metric using the neural network model; generating error data for the specific metric based on the differences between the predicted values and measured values; estimating the distribution of errors for the specific metric using the generated error data; and performing anomaly determination for the specific metric by comparing the estimated distribution with a normal distribution.

As another example, the computer program 206 may include instructions for performing the operations of: acquiring trace data related to at least one service of the target system 11; generating response time data for a specific service by analyzing the trace data; estimating the distribution of response times for the specific service using the generated response time data; and performing anomaly determination for the specific service by comparing the estimated distribution with a normal distribution.

As yet another example, the computer program 206 may include instructions for performing at least some of the steps/operations/methods described above with reference to FIGS. 1 through 19.

In the above-described examples, the system 10 according to some embodiments of the present disclosure may be implemented by the computing device 200.

In some embodiments, the computing device 200 may be a virtual machine implemented based on cloud technology. For example, the computing device 200 may be a virtual machine operating on one or more physical servers included in a server farm. In this case, at least some of the components of the computing device 200, including the processor 201, memory 202, and storage 205, may be implemented as virtual hardware, and the communication interface 204 may be implemented as a virtualized networking element such as a virtual switch.

So far, various embodiments of the present disclosure and effects according to the embodiments have been described with reference to FIGS. 1 to 20. The effects according to the technical idea of the present disclosure are not limited to the effects mentioned above, and other effects that are not mentioned may be obviously understood by those skilled in the art from the following description.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation. The scope of protection of the present invention should be interpreted in accordance with the claims below, and all technical ideas within the equivalent scope should be construed as being included in the scope of rights of the technical ideas defined by this disclosure.

What is claimed is:

1. An anomaly detection system, comprising:
at least one processor; and
a memory storing a computer program executed by the at least one processor,
wherein the computer program includes instructions for operations of: acquiring a neural network model configured to predict a metric value for a specific time point for a target system; outputting a predicted value for a specific metric via the neural network model; generating error data for the specific metric based on a difference between the predicted value and a measured value; estimating a distribution of errors for the specific metric using the generated error data; and performing anomaly determination for the specific metric by comparing the estimated distribution with a normal distribution, which is a distribution derived from error data for the specific metric obtained when the target system operates normally.

2. The anomaly detection system of claim 1, wherein the neural network model is trained in an unsupervised or semi-supervised manner based on a normal metric dataset.

3. The anomaly detection system of claim 1, wherein the neural network model is trained through a task of predicting a metric value for a future time point based on input metric data.

4. The anomaly detection system of claim 1, wherein the neural network model is trained through a task of reconstructing, from input metric data, at least some metric values of the input metric data.

5. The anomaly detection system of claim 1, wherein the neural network model is configured to receive time-series data for a plurality of metrics, analyze the received time-series data, and output metric values for the specific time point for the plurality of metrics.

6. The anomaly detection system of claim 1, wherein the operation of estimating the distribution of errors for the specific metric comprises estimating the distribution of errors for the specific metric using a kernel density estimation (KDE) method.

7. The anomaly detection system of claim 1, wherein the operation of performing anomaly determination for the specific metric comprises determining whether the measured value for the specific metric is an outlier based on a degree of overlap between the estimated distribution and the normal distribution.

8. The anomaly detection system of claim 7, wherein the operation of determining whether the measured value for the specific metric is an outlier comprises determining that the measured value for the specific metric is an outlier when no overlap exists between the estimated distribution and the normal distribution.

9. The anomaly detection system of claim 7, wherein the operation of determining whether the measured value for the specific metric is an outlier comprises: determining a first representative value of the estimated distribution and a second representative value of the normal distribution; calculating a sum of probability values according to the estimated distribution and the normal distribution for each of at least some values in a section between the first and second representative values; and determining the degree of overlap by comparing a maximum of the calculated sums with zero.

10. The anomaly detection system of claim 1, wherein
the target system is a microservice architecture-based system,
the neural network model is configured to predict a metric value for a first microservice of the target system, and
the computer program further includes instructions for operations of: acquiring another neural network model configured to predict a metric value at a specific time point for a second microservice of the target system; and performing anomaly determination for the second microservice using error data generated via the other neural network model.

11. An anomaly detection system, comprising:
at least one processor; and
a memory storing a computer program executed by the at least one processor,
wherein the computer program includes instructions for operations of: acquiring trace data related to at least one service of a target system; generating response time data for a specific service among the at least one service by analyzing the trace data; estimating a distribution of response times for the specific service using the generated response time data; and performing anomaly determination for the specific service by comparing the estimated distribution with a normal distribution, which is a distribution derived from response time data obtained when the specific service operates normally.

12. The anomaly detection system of claim 11, wherein the target system is a microservice architecture-based system.

13. The anomaly detection system of claim 11, wherein
the trace data includes multiple trace records, and
the operation of generating the response time data comprises: calculating a first plurality of response times for the specific service by analyzing a duration of a span associated with the specific service in each of the multiple trace records; determining a first representative response time based on the first plurality of response times; and generating the response time data including the first representative response time.

14. The anomaly detection system of claim 13, wherein the operation of determining the first representative response time comprises: determining the first representative response time based on response times that exceed a threshold, which is greater than a median of the first plurality of response times, among the first plurality of response times.

15. The anomaly detection system of claim 13, wherein the computer program further includes instructions for operations of: calculating a second plurality of response times for another service among the at least one service by analyzing the trace data, wherein a number of response times in the second plurality of response times differs from a number of response times in the first plurality of response times; determining a second representative response time based on the second plurality of response times; generating response time data for the other service including the second representative response time; and performing anomaly determination for the other service based on the response time data for the other service.

16. The anomaly detection system of claim 11, wherein the operation of performing anomaly determination for the specific service comprises: determining whether an anomaly has occurred in the specific service based on a degree of overlap between the estimated distribution and the normal distribution.

17. The anomaly detection system of claim 16, wherein the operation of determining whether an anomaly has occurred in the specific service comprises: determining that an anomaly has occurred in the specific service when no overlap exists between the estimated distribution and the normal distribution.

18. The anomaly detection system of claim 16, wherein the operation of determining whether an anomaly has occurred in the specific service comprises: determining a first representative value of the estimated distribution and a second representative value of the normal distribution; calculating a sum of probability values according to the estimated distribution and the normal distribution for each of at least some values in a section between the first and second representative values; and determining the degree of overlap by comparing a maximum of the calculated sums with zero.

19. An anomaly detection method performed by at least one processor, comprising:
acquiring a neural network model configured to predict a metric value for a specific time point for a target system;
outputting a predicted value for a specific metric via the neural network model; generating error data for the specific metric based on a difference between the predicted value and a measured value;
estimating a distribution of errors for the specific metric using the generated error data; and
performing anomaly determination for the specific metric by comparing the estimated distribution with a normal distribution,
wherein the normal distribution is a distribution derived from error data for the specific metric obtained when the target system operates normally.

20. An anomaly detection method performed by at least one processor, comprising:
acquiring trace data related to at least one service of a target system;
analyzing the trace data to generate response time data for a specific service among the at least one service;
estimating a distribution of response times for the specific service using the generated response time data; and
performing anomaly determination for the specific service by comparing the estimated distribution with a normal distribution,
wherein the normal distribution is a distribution derived from response time data obtained when the specific service operates normally.
